(19) United States
(12) Patent Application Publication
(10) Pub. No.: US 2009/0052628 A1
(43) Pub. Date: Feb. 26, 2009

(54) TARGET FOIL FOR USE IN THE PRODUCTION OF [18F] USING A PARTICLE ACCELERATOR

(75) Inventors: John Scott WILSON, EDMONTON (CA); Stephen Andrew McQUARRIE, Sherwood Park (CA); Richard JOHNSON, Richmond (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: GOVERNORS OF THE UNIVERSTY OF ALBERTA, Edmonton (CA)

(21) Appl. No.: 11/844,896

(22) Filed: Aug. 24, 2007

(51) Int. Cl. H01J 35/08

(52) U.S. Cl. 378/143

(57) ABSTRACT

The invention is directed to a novel foil for use as an entrance window foil during the production of [¹⁸F] by irradiation of [¹⁸O] using a particle accelerator. The foil is a high strength cobalt based alloy foil, thin film coated with an inert and refractory metal such as niobium.

### FIELD OF THE INVENTION

The present invention is directed to a target foil for use in the production of [¹⁸F] using a particle accelerator and to a method of producing [¹⁸F] using the target foil as part of the target assembly.

### BACKGROUND

Positron emission tomography, or PET as it is commonly referred to, is a nuclear medicine medical imaging technique that produces a three-dimensional image or map of functional processes in the body. To conduct the scan, a short-lived radioactive tracer isotope, which decays by emitting a positron, which also has been chemically incorporated into a metabolically active molecule, is injected into the living subject (usually into the subject's blood circulation). There may be a waiting period while the metabolically active molecule becomes concentrated in tissues of interest and then the living subject is placed in the imaging scanner.

As the radioisotope undergoes positron emission decay (also known as ‘positive beta decay’), it emits a positron, the antimatter counterpart of an electron. When the emitted positron collides with an electron, electron-positron annihilation occurs causing a pair of annihilation (gamma) photons to be produced. The annihilation (gamma) photons move in almost opposite directions. Typically they are detected when they reach a scintillator material in the scanning device, creating a burst of light which is detected by photomultiplier tubes or silicon avalanche photodiodes (Si APD). The technique depends on simultaneous or coincident detection of the pair of photons; photons which do not arrive in pairs (i.e., within a few nanoseconds of each other) are disregarded.

The most significant fraction of electron-positron decays result in two 511 keV gamma photons being emitted at almost 180° to each other; hence it is possible to localize their source along a straight line of coincidence (also called formally the “line of response” or ‘LOR’). In practice the LOR has a finite width as the emitted photons are not exactly 180° apart. If the recovery time of detectors is in the picosecond range rather than the 10's of nanosecond range, it is possible to calculate the single point on the LOR at which an annihilation event originated, by measuring the “time of flight” of the two photons. Using previously collected statistics from tens-of-thousands of coincidence events, a set of simultaneous equations for the total activity of each parcel of tissue along many LORs can be solved by a number of techniques, and thus a map of radioactivities as a function of location for parcels or bits of tissue (“voxels”), may be constructed and plotted. The resulting map shows the tissues in which the molecular probe has become concentrated, and can be interpreted by nuclear medicine physician or radiologist in the context of the patient's diagnosis and treatment plan.

[¹⁸F]fluoride (t_{1/2}=109.7 h, 97% β⁺) is by far the most widely used radionuclide in positron emission tomography (PET) and will continue to play a major role in the radiolabeling of new radiopharmaceuticals by nucleophilic fluorination which is the only current available method for non-carrier-added reactions with [¹⁸F]F⁻ (Berridge and Tewson 1986a). The major synthetic product made with [¹⁸F] is [¹⁸F] 2-fluoro-2-deoxyglucose (FDG) which dominates the field of PET Nuclear Medicine. FDG is available in many major centers due to the presence of cyclotron facilities. The possibility of providing FDG to PET imaging sites far away from the FDG production facility has resulted in the demand for ever larger quantities of FDG to be made to compensate for the huge decay losses experienced in transport.

There are several routes for the production of reactive [¹⁸F] (Nickles et al. 1986); however, production of non-carrier-added high specific activity [¹⁸F]fluorine is best achieved by proton irradiation of [¹⁸O]H₂O targets via the ¹⁸O(p,n)¹⁸F reaction (Guillaume et al. 1991). During the last two decades there has been a continuous development of targetry systems for the production of aqueous [¹⁸F]F⁻ ion (Wieland and Wolf 1983, Kilbourn et al. 1984, Huszár and Weinreich 1985, Kilbourn et al. 1985, Berridge and Tewson 1986b, DeJesus et al. 1986, Keikonen et al. 1986, Vogt et al. 1986, Wieland et al. 1986, Iwata et al. 1987, Qaim et al. 1987, Solin et al. 1988, Heselius et al. 1989, Mulholland et al. 1989, Steinbach et al. 1990, Schlyer et al. 1993, Berridge and Kjellström 1995, Roberts et al. 1995, Van Brockling et al. 1995, Berridge et al. 1999, Zeisler et al. 2000, Berridge et al. 2002, Nye et al. 2003, Nye et al. 2006, Johnson et al. 2007). The most important considerations for the design of a high power target for the production of aqueous [¹⁸F]fluoride under pressurized conditions are the selection of the appropriate materials for the body of the target chamber and entrance window foil. The choice of these materials must meet good mechanical strength, adequate thermal performance and chemical inertness to guarantee stability and efficient heat dissipation of the system for the production of large amounts of [¹⁸F] without sacrificing its reactivity.

The amount of [¹⁸F] produced from water targets is a direct relation of the amount of current on target multiplied by the length of time of irradiation. Ionic contaminants generated from beam interactions with the target body chamber and foil can lower the quality of the [¹⁸F] produced and result in lower synthetic yields of FDG and other products. Ionic contamination has led to frequent rebuilding of the target to maintain an adequate reactivity of fluoride for the routine production of clinical FDG (Kilbourn et al. 1984, Tewson et al. 1988, Solin et al. 1988, Schlyer et al. 1993). Target bodies of refractory materials such as titanium (Ti), tantalum (Ta) and niobium (Nb) were introduced to alleviate the fouling problem of the target body surfaces and lengthen the maintenance intervals (Zeisler 200 et al., Berridge et al. 2002, Nye et al. 2002, Satyamurthy et al. 2002, Nye et al. 2006).

Havar™ foils are often used for high pressure target applications due to its relatively high strength and flexibility. However, there are disadvantages to the use of Havar™ target entrance foils including high radioactivation with proton beam currents, moderate heat conduction and the formation of water soluble contaminants leading to problems with [¹⁸F] chemical reactivity.

Many alternate materials with desirable properties for beam current applications lack the necessary strength to act as target foils. Niobium (Nb) is one such material. Nb has excellent high temperature heat characteristics, is inert to fluoride, and has a very high melting point. However, the weak mechanical properties of Nb constrain the use of foils made of this material to relatively lower pressures making them not suitable for the routine production of [¹⁸F] under pressurized conditions (Nye et al. 2006).

It is apparent that there is a need in the art for a target foil which mitigates the difficulties of the prior art.

### SUMMARY OF THE INVENTION

In one aspect, the invention comprises a target foil for use in the production of aqueous [¹⁸F] using a cyclotron to irradiate aqueous [¹⁸O]—H₂O, the foil comprising a high strength foil thin film coated with an inert and refractory metal.

In one embodiment, the inert and refractory metal is deposited onto the high-strength foil by sputter deposition. In one embodiment the inert metal is titanium, tantalum or niobium. In one embodiment the inert metal film is between about, 100 nm and about 1000 nm, preferably about 150 nm and 500 nm, and more preferably between about 190 nm and 210 nm. In one preferred embodiment, the inert metal film comprises niobium.

In one embodiment, the high-strength foil comprises a metal alloy having a tensile strength of at least about 1200 MPa, and preferably greater than about 1500 mPa and more preferably greater than about 1800 MPa. Preferred high strength foils comprise a cobalt-based alloy, such as Havar™ foil.

In a further aspect of the present invention, it comprises a method of producing aqueous [¹⁸F] comprising the steps of;
(a) placing aqueous [¹⁸O]—H₂O in a high pressure target chamber;
(b) sealing the target chamber with a target foil, the target foil comprising a high strength foil thin film coated with an inert and refractory metal; and
(c) using a cyclotron to direct a beam of high energy protons at the target foil.

In one embodiment, the target chamber comprises niobium. In one embodiment, the inert metal is titanium, tantalum or niobium. In one embodiment, the inert metal is coated onto the Havar™ foil by sputter deposition.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 is a chart showing decay corrected FDG yield as a function of integrated bombardment current for the production of aqueous [¹⁸F]fluoride using Havar™ entrance foils.

FIG. 2 is a chart showing decay corrected FDG yield as a function of integrated bombardment current for the production of aqueous [¹⁸F]fluoride using Havar™-Nb sputtered entrance foils.

FIG. 3 is a chart showing timeline FDG yield production using [¹⁸F]F⁻ from a [¹⁸O]H₂O target with Havar™ entrance foils showing foil change intervals (arrows).

FIG. 4 is a chart showing timeline FDG yield production using [¹⁸F]F⁻ from a [¹⁸O]H₂O target with Havar™-Nb sputtered entrance foils showing foil change intervals (arrows).

FIG. 5 shows a proton beam strike produced on a Havar™ entrance window foil after 2042 μAh of integrated current beam exposure.

FIG. 6 shows a proton beam strike produced on a Havar™-Nb sputtered entrance window foil and shows the formation of the protective Nb₂O₅ film on the surface of the Havar™-Nb coated foil, after 5585 μAh of integrated current beam exposure.

FIG. 7 is a diagrammatic depiction of a sputter coating system.

FIG. 8 is a diagrammatic depiction of a basic system for the production of [¹⁸F].

### DETAILED DESCRIPTION OF PREFERRED EMBODIMENTS

The invention relates to a target foil for use in the production of [¹⁸F] using a cyclotron and to a method of producing [¹⁸F] using the target foil.

When describing the present invention, all terms not defined herein have their common art-recognized meanings. Throughout this disclosure, various publications may be referenced. Where permissible, the disclosures of these publications are hereby incorporated by reference in their entirety into the present disclosure to more fully describe the state of the art. To the extent that the following description is of a specific embodiment or a particular use of the invention, it is intended to be illustrative only, and is not intended to be limiting of the claimed invention. The following description is intended to cover all alternatives, modifications and equivalents that are included in the spirit and scope of the invention, as defined in the appended claims.

“Cyclotron” refers to device that is a particle accelerator which uses electric fields to propel electrically charged particles to high speeds and to contain them.

“Inert” means stable and not chemically reactive.

“Refractory” means the quality of a material to retain its strength at high temperatures. In preferred embodiments, refractory materials are resistant to thermal shock, are chemically inert and have low thermal conductivities and coefficients of expansion.

There are several routes for the production of reactive [¹⁸F] however, [¹⁸F] production of non-carrier-added high specific activity [¹⁸F]fluorine is best achieved by proton irradiation of [¹⁸O]H₂O targets via the ¹⁸O(p,n)¹⁸F reaction. FIG. 8 shows a diagrammatic side view of one embodiment of a basic target system used to produce aqueous [¹⁸F]. The oxygen enriched water to be irradiated is held in a high pressure target that is comprised a metallic cavity, or target chamber (12), as it is known, sealed with a metal foil (10) which serves as the beam entrance window. Niobium is commonly used for the target chamber. The metal foil is known as the ‘foil’, the ‘target foil’ or the ‘entrance window foil’. A cyclotron (not shown) is used to generate a beam (P) of high energy protons (˜65 uA). The beam is directed towards the target and the protons go through the target foil (10) and into the oxygen enriched water in the target chamber (12).

The interaction of the high energy proton beam (P) with the water results in the nuclear ¹⁸O(p,n)¹⁸F reaction and produces aqueous [¹⁸F]. Specifically, the high energy protons interact with the nucleus of the [¹⁸O] turning it into [¹⁸F]. [¹⁸O] has 8 protons and 10 neutrons in the nucleus. [¹⁸F] has 9 protons and 9 neutrons. Protons and neutrons have the same weight so [¹⁸F] and [¹⁸O] have the same weight 18 AMU (Atomic Mass Units) but are different elements. The high energy protons from the beam (P) knock out and replace a neutron from the nucleus of [¹⁸O], causing the weight to stay the same, but creating a new element, [¹⁸F]. [¹⁸F] is radioactive and unstable, in contrast to [¹⁸O] which is stable and found in nature. [¹⁸F] decays back to [¹⁸O], emitting positrons as it does so. The half life of [¹⁸F] is 109.7 minutes.

The high current proton beam (P) generates high temperatures and pressures in the target chamber (12). A water stream (W) and a helium stream (H) is used to cool the apparatus during the irradiation process. In particular, the target foil (10) must be cooled continuously to prevent rupture in the face of the extreme temperature caused by the beam (P). The foil of the present invention may be used with any suitable particle accelerator including, without limitation, the TR19/9 cyclotron from Advanced Cyclotron Systems.

The cyclotron and the target chamber are well known in the art and need not be further described herein. Suitable configurations are well within the routine skill of one skilled in the art.

The most important considerations for the design of a high power target for the production of aqueous [¹⁸F]fluoride are the selection of the appropriate materials for the body of the target chamber and target foil. The choice of these materials must meet high mechanical strength, adequate thermal performance and chemical inertness to guarantee stability and efficient heat dissipation of the system for the production of large amounts of [¹⁸F] without sacrificing its reactivity. Proton beams are stopped relatively easily by atomic obstacles, and accordingly the target foil must be as thin as possible whilst maintaining mechanical integrity in the face of both high pressures from within the chamber and extreme heat generated by the beam.

For example, the high melting point (2477° C.) of Nb and its excellent chemical resistance to the corrosive conditions in superheated environments (El-Genk and Tournier 2005) has made this material very attractive for the construction of body targets for the high power production of aqueous [¹⁸F] (Zeisler et al. 2000, Berridge et al. 2002, Nye et al. 2006). On the other hand, the weak mechanical properties of Nb constrain the use of foils of this material to pressures less than 2×10⁴ torr. As a result, they are not suitable for the routine production of [¹⁸F] under pressurized conditions (Nye et al. 2006). Similarly, this limitation is experienced when trying to use other suitable inert metals such as Ti and Ta to make foils.

Havar™ is a high tensile strength (1860 MPa) non-magnetic alloy (42% Co, 19.5% Cr, 12.7% Ni, 2.7% W, 2.2 Mo, 1.6% Mn, 0.2% C and bal. Fe) with a high melting point (1480° C.) and a moderate thermal conductivity (14.7 W m⁻¹ K⁻¹ @ 23° C.). These properties have resulted in Havar™ being used in entrance window foils of pressurized targets for the production of aqueous [¹⁸F]. However, high power irradiations lead to the formation of water soluble contaminants affecting the reactivity the [¹⁸F] and decreasing the labeling yield of radiopharmaceuticals. This problem becomes more prevalent as there appears to be a movement towards the greater use and development of new high current water targets to meet the demand of supplying multiple sites with a regional cyclotron. Such supply issues will lead to an increase in the demand for high purity [¹⁸F] in the very high temperature, caustic aqueous water target environment.

We have found that using thin film deposition techniques to coat high-strength foil with an inert and refractory metal provides suitable target foils. The high-strength foil preferably has a tensile strength of at least about 1200 MPa, and preferably greater than about 1500 MPa, and more preferably greater than about 1800 MPa. The present invention combines the properties of robust strength and flexibility with the advantage of non-reactivity and inertness during the extreme conditions created under the high power irradiation of water pressurized targets. The coated high strength foil permits the use of higher beam currents which facilitates production of relatively larger quantities of [¹⁸F] at high levels of purity. Although one exemplary embodiment described in this description is directed to Havar™ coated with Nb, any suitable inert and refractory metal having comparable beneficial properties of Nb may be used to coat a high strength foil to create the target foils of the present invention. Such inert and refractory metals include, without limitation, titanium, tungsten, molybdenum, tantalum and rhenium.

The high strength foil may comprise a cobalt-based alloy, such as Havar™ or other cobalt-based alloys known to have high tensile strength and are which are non-magnetic. Examples include the following commercially available alloys:
ELGILOY™, ASTM standard F1058-91, from Elgiloy Limited Partnership, Elgin, Ill. The compositional ranges of the various elements are by weight percent of the total material:

TABLE 1

From about 39% to about 41% cobalt;
about 19% to about 21% chromium;
about 15% to about 16% nickel;
about 6% to about 8% molybdenum;
about 1% to about 2% manganese;
and wherein the sum of carbon and beryllium is in an
amount less than or equal to about 0.20%; and the
remainder comprising iron.

MP35N™ from SPS Technologies, Inc., Newton, Pa. The compositional ranges of the various elements are by weight percent of the total material:

TABLE 2

From about 28% to about 40% cobalt;
about 19% to about 21% chromium;
about 33% to about 37% nickel;
about 9% to about 11% molybdenum;
about 0.01% to about 1% iron; and
about 0.01% to about 1% titanium;
and wherein the sum of manganese, silicon, and carbon is
in an amount less than or equal to about 0.5%.

ULTIMET™ from Haynes International, Inc., Kokomo, Ind. The compositional ranges of the various elements are by weight percent of the total material:

TABLE 3

From about 51% to about 57% cobalt;
about 23.5% to about 27.5% chromium;
about 7% to about 11% nickel;
about 4% to about 6% molybdenum;
about 1% to about 5% iron;
about 1% to about 3% tungsten;
about 0.1% to about 1.5% manganese;
and wherein the sum of silicon and carbon is in an
amount less than or equal to about 1.1%. In a preferred
formulation of the ULTIMET ™ alloy, cobalt
comprises about 54%.

L605™, series R30605 from Carpenter and under the trademark HAYNES™ 25, ASTM standard F90-92 from Haynes International, Inc. The compositional ranges of the various elements are by weight percent of the total material:

TABLE 4

From about 45% to about 57% cobalt;
about 19% to about 21% chromium;
about 9% to about 11% nickel;
about 14% to about 16% tungsten;
about 0% to about 3% iron;
about 1% to about 2% manganese;
and wherein the sum of silicon and carbon is in an
amount less than or equal to about 0.60%.

Thus, the preferred cobalt-based alloys of the present invention comprise at least about 25% cobalt, and preferably greater than about 30%, and more preferably, greater than about 40% cobalt, at least about 15% chromium, and at least about 5% nickel. The alloys may also comprise tungsten, molybdenum and/or manganese in amounts of about 0% to about 15%. Minor amounts (<5%, and preferably less than about 1%) of iron, carbon, titanium, silicon, sulphur, phosphorus and boron may be included.

The high-strength foil can be coated using any suitable thin film deposition technique that facilitates an even coat that is very strongly bonded to the high-strength foil. A durable bond is important due the extreme environment of the target during irradiation. “Thin film deposition” as used herein refers to any technique for depositing a thin film of the inert metal onto the high-strength foil substrate, or onto previously deposited layers of the inert material on the high-strength foil substrate. “Thin film” as used herein refers to layer thicknesses that can be controlled within a few tens of nanometres. Deposition techniques may be directed to chemical deposition methodologies including, without limitation, plating or chemical vapor deposition. Alternatively, physical deposition processes may be employed including, without limitation, arc-PVD, cathodic arc deposition, pulsed laser deposition or sputter deposition.

It has been found that the use of sputter deposition to sputter a thin layer of the inert material onto the high-strength is particularly well suited to making robust target foils for use in the production of [¹⁸F]. The sputtered metal is bonded very strongly to the high strength foil and acts as a foil of the pure metal.

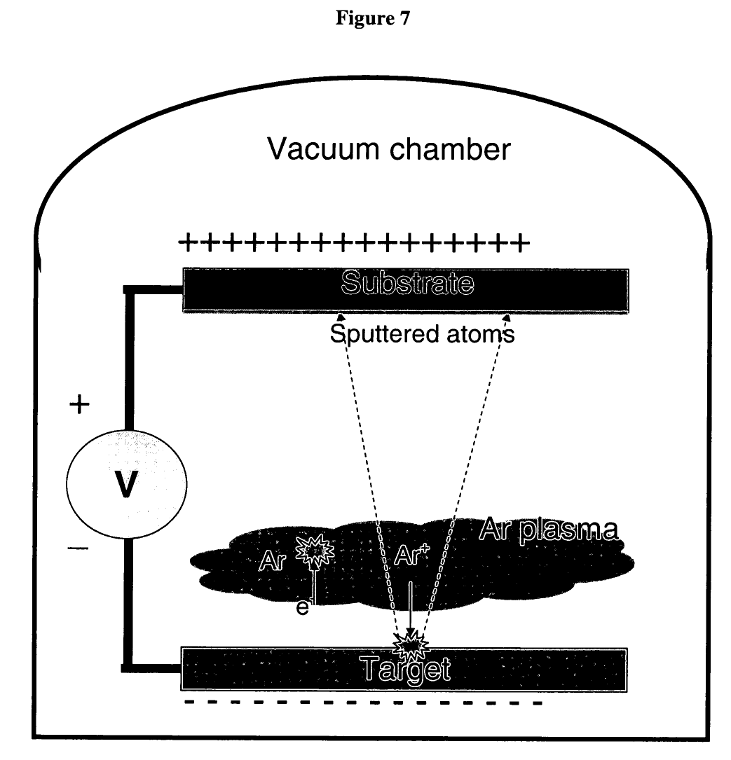

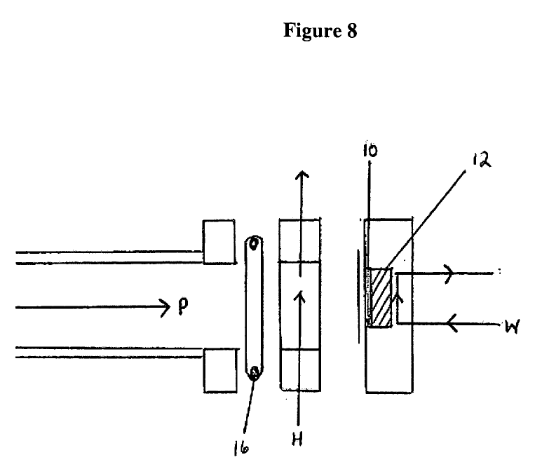

Thus, in a preferred embodiment, the Nb layer is deposited by sputter deposition, or sputtering as it is also known, onto a Havar™ substrate. Sputtering methods are well known in the art, such as DC magnetron sputtering. A basic sputtering system is depicted diagrammatically in FIG. 7. To sputter coat a target material onto a substrate, a high voltage (˜500V) is applied between the target and the substrate to establish a strong electric field. Free electrons accelerated by the electric field collide with introduced Argon (Ar) gas atoms, ionizing them into Ar+ and freeing more electrons. Heavy Ar+ ions are in turn accelerated by the electric field towards the target, causing the atoms of the target material to be sputtered (ejected) upon collision. The sputtered target atoms get deposited on the substrate, forming a thin film of the target material on the substrate. A vacuum environment is required for purity of the thin film and a long mean free path of the sputtered material. Magnetron sputtering may also be employed to make the foils of the present invention. In magnetron sputtering, a magnetic field is set up to confine electrons to the region around the target in order to improve sputtering efficiency and performance. The aforementioned description is that of a basic sputtering system, however any suitable system for sputter coating Havar™ foil with an inert metal may be employed to prepare the foils of the present invention.

The method of deposition must create sufficient bond between the deposited layer and the substrate such that the produced target foil meets the strength and refractory properties. In a preferred embodiment, the method of deposition is DC magnetron sputtering.

The high strength foil is typically between about 25 and 38 μm thick, depending on the tensile strength of the chosen alloy, and the inert metal sputtered layer may be between about 100 nm and 1000 nm thick. In one embodiment, the sputtered layer is between about 150 to about 500 nm and may preferably be about 190 to 210 nm.

### EXAMPLES

### Sputtering

A thin film of Nb metal was deposited onto a Havar™ foil using a planner magnetron sputter system™. Prior of the deposition of Nb, the Havar™ foil was cleaned by wiping the foil with IPA using a particle free clean room wipe before it was loaded into the vacuum chamber. The Havar™ foil substrate was mounted on a rotating substrate holder that rotated at about 20 rpm. The system was then closed and pumped down to the desired base pressure. Lower base pressures are preferable to reduce the proportion of reactive atoms, such as oxygen that are present during the metal deposition. Preferably, there is just argon present at approximately 7×10⁻³ torr during the deposition. The Havar™ foil was also exposed to a 5 minute-long RF back etch at 100 W to clean and roughen its surface. This improves the adhesion of Nb on the Havar™ foil surface and reduces the risk of the Nb sputtered layer coming off during the irradiation of the foil. The Havar™ foil was then coated with Nb via 21 minutes and 17 seconds of DC (345±15 V) sputtering at a base pressure in the range of 1-3×10⁻⁷ torr. The operating pressure for both the RF and DC portion was 7×10⁻³ torr. The Nb sputtered film thickness was on the order of 188±20 nm as measured by using a Tencor Alphastep 200 profilometer.

### Production of [¹⁸F] and FDG Synthesis

Irradiations were performed at the Edmonton PET Centre on a TR19/9 cyclotron from Advanced Cyclotron Systems. The production of [¹⁸F] was carried out using a water target with a Nb chamber and both Havar™ and Havar™-Nb sputtered entrance window foils. Typical production runs lasted for 1-2 h at an average current of 65 μA of 17.5 MeV protons. [¹⁸F]FDG was synthesized by the Hamacher method (Hamacher et al. 1986) using a GEMS TracerLab MX (Coincidence) FDG Synthesizer from Bioscan.

### Test Results

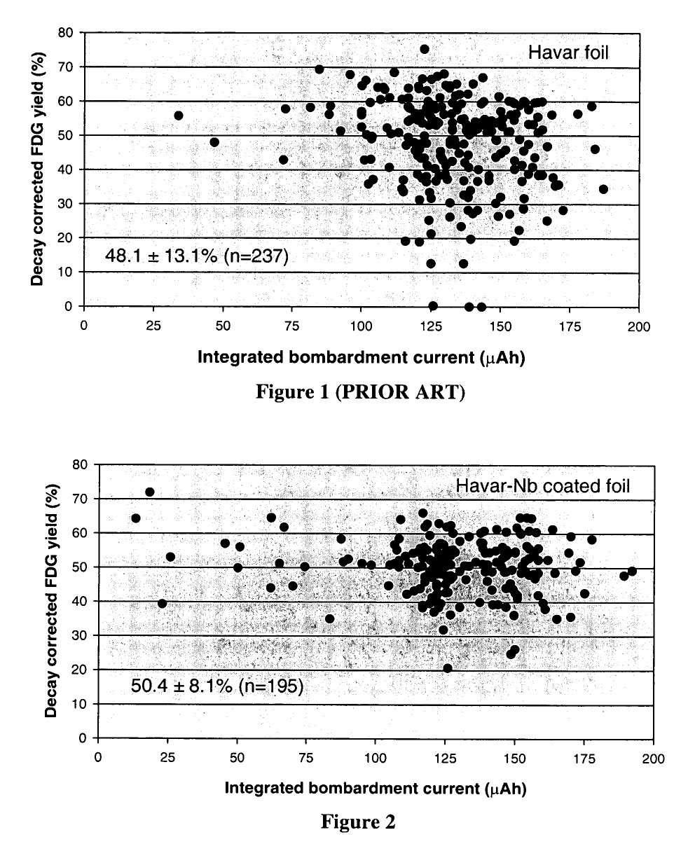

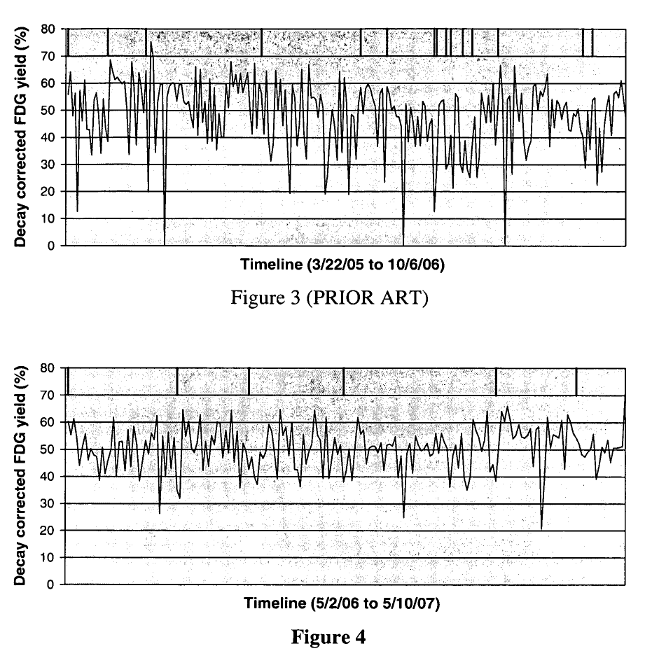

FIGS. 1 and 2 show the decay corrected FDG synthesis yields as a function of the integrated bombardment current for the production of [¹⁸F] over a period of more than two years using both Havar™ and Havar™-Nb sputtered foils. FIGS. 3 and 4 show the same FDG yields arranged in a timeline showing the changing frequency of the entrance window foils. On average, the FDG synthesis yield using fluorine from the target with the Havar™-Nb sputtered foils was found to be slightly higher (˜5%) compared with the yield using fluorine from the target with the Havar™ foil. More notably however, FIGS. 1-4 show an improvement on the FDG yield consistency and in the frequency of target rebuilding when using the target with the Nb sputtered foil.

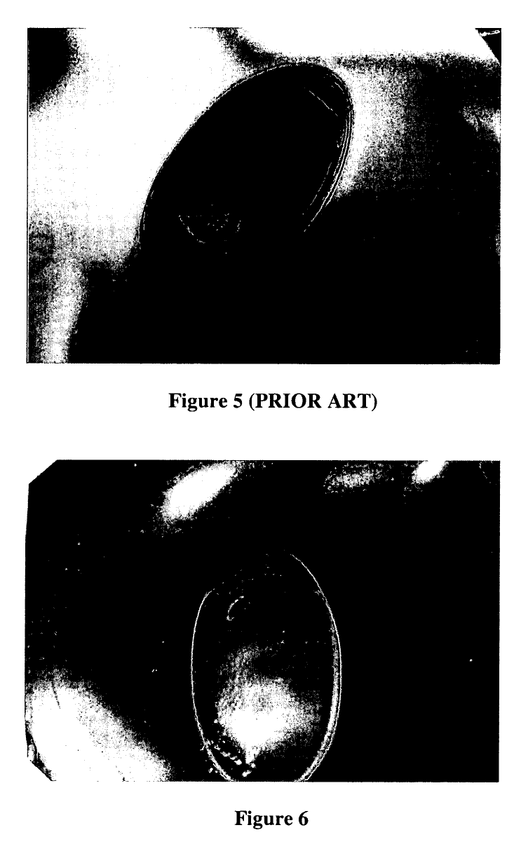

FIGS. 5 and 6 show the beam strike produced on both Havar™ and Havar™-Nb sputtered entrance window foils after a prolonged exposure to the proton beam. FIG. 6 shows the formation of the protective oxide film (Nb₂O₅) on the surface of the Havar™-Nb coated foil. The typical changing frequency of Havar™ foils is 2000 μAh while the nominal changing frequency of Nb sputtered foils is 8000 μAh. There has been no indication that beam current limits have been reached with the Havar™-Nb whereas the Havar™ foils show a serious breakdown under similar and even under lower current conditions.

The following references are cited in the application at the relevant portion of the application. Each of these references is incorporated herein by reference, where permitted.
Berridge M S and Tewson T J (1986a) Chemistry of fluorine-18 radiopharmaceuticals, Appl. Radiat. Isot. 37, 685-693.
Berridge M S and Tewson T J (1986b) Effects of target design on the production and utilization of [¹⁸F]fluoride from [¹⁸O] water, J. Label. Compd. Radiopharm. 23, 1177-1178.
Berridge M S and Kjellström R (1995) Fluorine-18 production: new designs for O-18 water targets, J. Label. Compd. Radiopharm. 26, 188-189.
Berridge M S and Kjellström R (1999) Designs and use of a silver [¹⁸O]water targets for [¹⁸F]fluoride production, Appl. Radiat. Isot. 50, 699-705.
Berridge M S, Voelker K W, Bennington B (2002) High-yield, low pressure [¹⁸O]water targets of titanium and niobium for F-18 production on MC-17 cyclotrons, Appl. Radiat. Isot. 57, 303-308.
DeJesus O T, Martin J A, Yasillo N J, Gatley S J, Cooper M D (1986) [¹⁸F]fluoride from a small cyclotron for the routine synthesis of [¹⁸F]2-fluoro-2-deoxy-glucose, Appl. Radiat. Isot. 37, 397-401.
El-Genk M S and Tournier J. (2005). A review of refractory metal alloys and mechanically alloyed-oxide dispersion strengthened steels for space nuclear power systems, J. Nucl. Mater. 340, 93-112.
Guillaume M, Luxen A, Nebeling B, Argentini M, Clark J C, Pike V W (1991) Recommendations for fluoride-18 production, Appl. Radiat. Isot. 42, 749-762.
Hamacher K, Coenen H H, Stöcklin G (1986) Efficient stereospecific synthesis of no-carrier-added 2-[¹⁸F]-fluoro-2-deoxy-D-glucose using aminopolyether supported nucleophillic substitution, J. Nuc. Med. 27, 235-238
Heselius S-J, Schlyer D J, Wolf A P (1989) A diagnostic study of proton-beam irradiated water targets, Appl. Radiat. Isot. 40, 663-669.
Huszár I and Weinreich R (1985) Production of ¹⁸F with an ¹⁸O-enriched water target, J. Radioanal. Nucl. Chem. Lett. 93, 349-354.
Iwata R. Ido T, Brady F, Takahashi T, Ujiie A (1987) [¹⁸F]fluoride production with a circulating [¹⁸O]water target, Appl. Radiat. Isot. 38, 979-984.
Johnson R R et al. (2007) Advances in intense beams, beam delivery, targetry, and radiochemistry at advanced cyclotron systems, Nucl. Inst. Meth. Phys. Res. B 261, 803-808.
Keikonen J, Fontell A, Kaireto A-L (1986) Effective small volume [¹⁸O]water target for the production of [¹⁸F]fluoride, Appl. Radiat. Isot. 37, 631-632.
Kilbourn M R, Hood J T, Welch M J (1984) A simple ¹⁸O water target for ¹⁸F production, Int. J. Appl. Radiat. Isot. 35, 599-602.
Kilbourn M R, Jerabek P A, Welch M J (1985) An improved [¹⁸O] water target for [¹⁸F]fluoride production, Int. J. Appl. Radiat. Isot. 36, 327-328.
Mulholland G K, Hichwa R D, Kilbourn M R, Moskwa J (1989) A reliable water target for fluorine-18 production at high beam currents, J. Label. Compd. Radiopharm. 26, 192-193.
Nickles R J, Gatley S J, Votaw J R, Kornguth M L (1986) Production of reactive fluorine-18, Appl. Radiat. Isot. 37, 649-661.
Nye J A, Dick D W, Nickles R J (2003) Pushing the limits of a ¹⁸O water target, AIP Conference Proceedings 680, 1098-1101.
Nye J A, Avila-Rodriguez M A, Nickles R J (2006) A grid-mounted niobium body target for the production of reactive [¹⁸F]fluoride, Appl. Radiat. Isot. 64, 539-539.
Qaim S M, Blessing G, Stöcklin G (1987) Routinely used cyclotron targets for radioisotope production at KFA Jülich, In: Proc. 2^{nd} Workshop on Targetry and Target Chemistry, Heidelberg 1985, pp. 50-57.
Roberts A D, Daniel L C, Nickles R J (1995) A high power target for the production of [¹⁸F]fluoride, Nucl. Inst. Meth. Phys. Res. B 99, 797-799.
Satyamurthy N, Amarasekera B, Alvord C W, Barrio J R, Phelps M E (2002) Tantalum [18°]water target for the production of [18F0fluoride with high reactivity for the preparation of 2-deoxy-2-[18F]fluoro-D-glucose, Mol. Imag. Biol. 4, 65-70.
Schlyer D J, Firouzbakht M L, Wolf A P (1993) Impurities in the [¹⁸O]water target and the effect on the yield of an aromatic displacement reaction with [¹⁸F]fluoride, Appl. Radiat. Isot. 44, 1459-1465.
Solin O, Bergman J, Haaparanta M, Reissell A (1988) Production of ¹⁸F from water targets. Specific radioactivity and anionic contaminants, Appl. Radiat. Isot. 39, 1065-1071.
Steinbach J, Guenther K, Loesel E, Grunwald G, Mikecz P, Andó L, Szelecsényi F, Beyer G J (1990) Temperature course in small volume [¹⁸O]water targets for [¹⁸F]F⁻ production, Appl. Radiat. Isot. 41, 448-449.
Tewson T J, Berridge M S, Bolomey L, Gould K L (1988), Routine production of reactive fluorine-18 fluoride salts from an oxygen-18 water target. Nuc. Med. Biol. 15, 499-504.
Van Brocklin H, Padgett H, Alvord C, Schmidt D, Bida G (1995) High pressure H₂¹⁸O target for the production of [¹⁸F]fluoride ion, In: Emran A M (Ed.), Chemists' view of imaging centers. Plenum Press, New York, pp. 329-338.
Vogt M, Huszár I, Argentini M, Oehninger H, Weinreich R (1986) Improved production of [¹⁸F]fluoride via the [¹⁸O]H₂O(p,n)¹⁸F reaction for non-carrier-added nucleophilic syntheses, Appl. Radiat. Isot. 37, 448-449.
Wieland B W and Wolf A P (1983) Large-scale production and recovery of aqueous [¹⁸F]fluoride using proton bombardment of a small-volume [¹⁸O]water target, J. Nucl. Med. 34, 122.
Wieland B W, Hendry G O, Schmidt D G, Bida G, Ruth T J (1986) Efficient small-volume O-18 water targets for producing F-18 fluoride with low energy protons, J. Label. Compd. Radiopharm. 23, 1205-1207.
Zeisler S K, Becker D W, Pavan R A, Moschel R, Rühle H (2000) A water-cooled spherical niobium target for the production of [¹⁸F]fluoride, Appl. Radiat. Isot. 53, 449-453.

What is claimed is:

1. A target foil for use in the production of aqueous [¹⁸F] using a cyclotron to irradiate aqueous [¹⁸O], the foil comprising a high-strength, non-magnetic foil thin film coated with an inert and refractory metal.

2. The foil of claim 1 wherein the inert and refractory metal is deposited onto the high strength foil by sputter deposition.

3. The foil of claim 1 wherein the inert metal is titanium, tantalum or niobium.

4. The foil of claim 3 wherein the inert metal is niobium.

5. The foil of claim 4 wherein the film thickness of the niobium coat is between about 100 nm to about 1000 nm.

6. The foil of claim 1 wherein the high strength foil comprises a cobalt-based alloy.

7. The foil of claim 6 wherein the high-strength foil comprises a cobalt-based alloy having a tensile strength of greater than 1200 MPa.

8. The foil of claim 6 wherein the high-strength foil comprises a cobalt-based alloy having a tensile strength of greater than 1500 MPa.

9. The foil of claim 6 wherein the high-strength foil comprises a cobalt-based alloy having a tensile strength of greater than 1800 MPa.

10. The foil of claim 6 wherein the high strength foil comprises an alloy composed of at least about 25% cobalt, at least about 15% chromium, and at least about 5% nickel.

11. The foil of claim 10 wherein the high strength foil comprises Havar™.

12. The foil of claim 10 wherein the inert metal is niobium.

13. A method of producing aqueous [¹⁸F] comprising;
(a) placing aqueous [¹⁸O] in a target chamber;
(b) sealing the target chamber with a target foil as claimed in claim 1; and
(c) using a particle accelerator to direct a beam of high energy protons at the target foil.

14. The method of claim 13 wherein the target chamber comprises niobium.

15. The method claim 13 wherein the inert metal is titanium, tantalum or niobium.

16. The method claim 15 wherein the inert metal is niobium.

17. The method of claim 13 wherein the inert metal is coated onto the high strength foil by sputter deposition.

18. The method of claim 13 where the particle accelerator is a cyclotron.
